(19) United States
(12) Patent Application Publication
(10) Pub. No.: US 2001/0029643 A1
(43) Pub. Date: Oct. 18, 2001

(54) Locking swivel caster wheel

(76) Inventors: James C. Schroeder, Ramsey, MN (US); Bradley K. Voigt, Maple Lake, MN (US)

Correspondence Address: Douglas B. Farrow,Esquire, Corporate Intellectual Property Counsel, Graco Inc., P.O. Box 1441, Minneapolis, MN, 55440-1441, US

(21) Appl. No.: 09/821,225

(22) Filed: Mar. 29, 2001

Related U.S. Application Data
(60) Provisional application No. 60/193,134, filed on Mar. 29, 2000.

(51) Int. Cl. B60B 33/00

(52) U.S. Cl. 16/35 R

(57) ABSTRACT

A caster wheel assembly that accommodates swiveling movement of a caster wheel providing a locking releasable wheel. The apparatus is applied to front wheel swivel caster assemblies permitting a high degree of reliability in linear motion for the supported article, along with a quick release of the front wheel. The precision linear motion for the supported article is achieved by a zero play locking mechanism that includes: a one bolt alignment adjustment, a reversible locking pin, and a integrated radius locking device. The design of the locking swivel caster wheel assembly is highly efficient in that the quick release of the front wheel provides fast and simple replacement, as well as incorporating the usage of multiple wheel types such as a wide profile wheel.

### RELATED APPLICATIONS

Provisional U.S. Application Ser. No. 60/193,134, filed Mar. 29, 2000.

### BACKGROUND OF THE INVENTION

Caster assemblies are widely known and commonly used in many industries. Caster assemblies may be grouped as swivel or rigid based depending on the type of movement they permit.

Swivel caster assemblies allow multi-directional movement of the apparatus to which they are affixed to a supported article. Rigid caster assemblies enable only linear movement of the apparatus to which they are attached to a supported article. Swivel caster assemblies can also be outfitted with a locking assembly which, when activated, restricts the pivoting movement of the assembly and thereby transforms it to a rigid caster assembly.

To allow the pivoting movement, swivel caster assemblies conventionally include a wheel assembly affixed to a supported article. The wheel assembly consist of a swivel component fixed to the lower face of the supported article, and forks projecting outward from the swivel component and attached to a wheel. The swivel component permits the wheel to rotate about an axis perpendicular to the wheel's axis of rotation. In this way, the wheel can easily adjust itself to an fitting direction under the effect of the weight from a load by the supported article.

Swivel assemblies usually use two sets of ball bearings to enable the pivoting movement of the wheel assembly with respect to the supported article. Conventionally, locking swivel assemblies can have difficulties achieving precision linear motion for the supported article, and exhibit timely adjustments. Also, traditionally locking swivel assemblies do not provide wheel assemblies with a quick release of the front wheel allowing fast and simple replacement, along with an option for the usage of multiple wheel types such as a wide profile wheel.

### SUMMARY OF THE INVENTION

It is there for the object of this invention to provide a locking swivel caster wheel assembly which is easily and inexpensively manufactured and which is capable of producing straighter lines (or precise linear motion), hold a wide profile wheel, have faster adjustment capabilities compared to the current prior art devices.

These and other objects and advantages of the invention will appear more fully from the following description made in conjunction with the accompanying drawings wherein like reference characters refer to the same or similar parts throughout the several views.

### A BRIEF DESCRIPTION OF THE DRAWINGS

FIG. 1 is a front left elevated perspective view of a swivel caster assembly incorporating the present invention.

FIG. 2 is a back right elevated perspective view of a swivel caster assembly incorporating the present invention.

FIG. 3 is front partial sectional view of instant invention.

FIG. 4 is a partial side view of the instant invention.

FIG. 5 is a top view of the instant invention.

FIG. 6 is a cross-sectional view along lines B-B of FIG. 5.

FIG. 7 is a partial exploded view of the wheel assemble for the instant invention.

FIG. 8 is a top view of the adjuster disk of FIG. 7.

FIG. 9 is a side view of the adjuster disk of FIG. 8.

FIG. 10 is side view of the shaft of FIG. 7.

FIG. 11 is a top view of the fork of FIG. 7.

FIG. 12 is a front view of the fork of FIG. 11.

FIG. 13 is a side view of the fork of FIG. 12.

FIG. 14 front view of the fork and shaft of FIG. 7.

FIG. 15 is a front view of the fork and shaft of FIG. 12.

FIG. 16

### DESCRIPTION OF THE PREFERRED EMBODIMENT

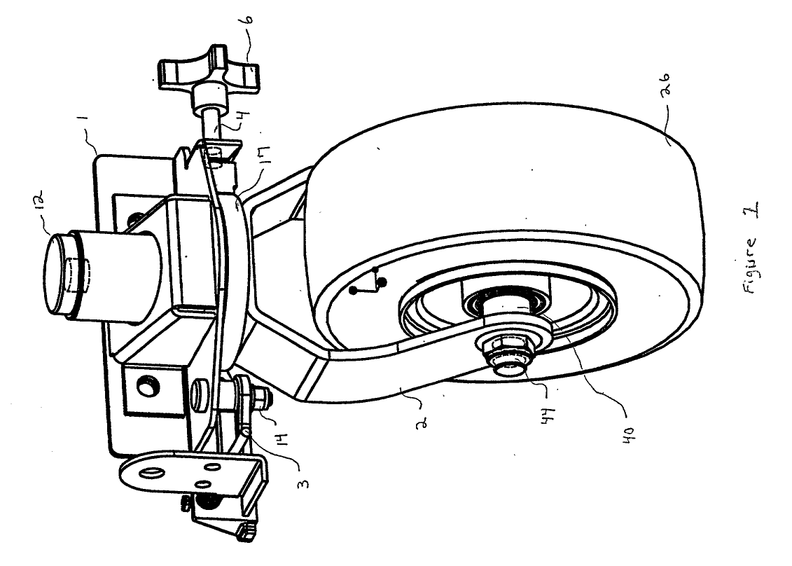

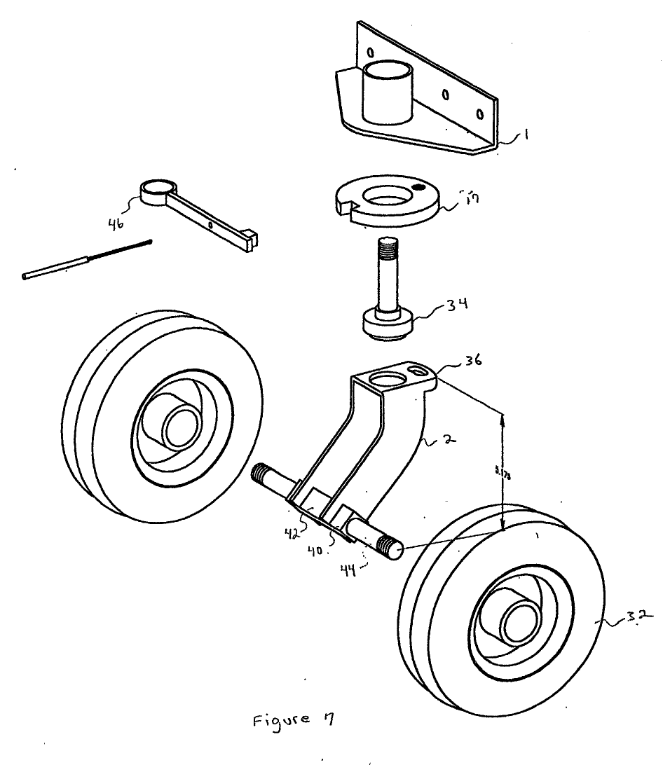

The instant invention is generally designated 30 and is comprised of a wheel assembly (30) rotatably attached to a hub bracket (1). The wheel assembly (30) having a plurality of wheel attachments contained within said wheel assembly (30). Referring to FIG. 1 a rotation pin (44) having a left and right floating non-rotational spacer (40) about said wheel (26) inside of the fork shafts (2). Referring to FIG. 7 a rotation pin (44) having a center floating non-rotational spacer (42) between said fork shafts (2) wherein said wheel (32) attach to both ends of said rotation pin (44) having left and right floating non-rotational spacer (40) between said wheel (32) and said fork shaft (2).

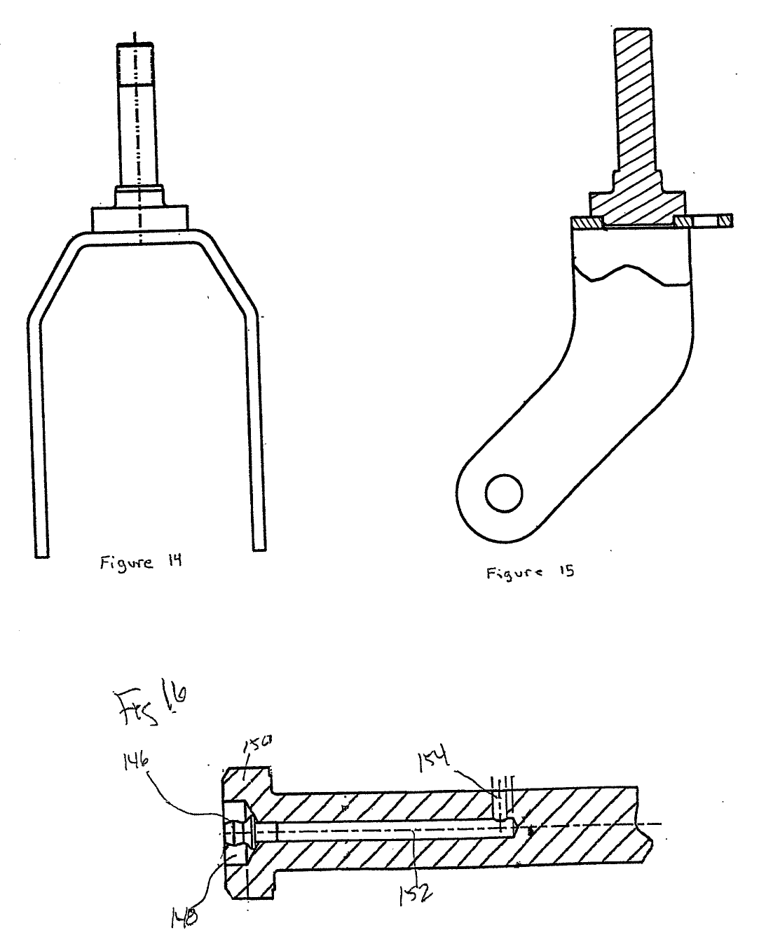

Referring to FIG. 14, a shaft (34) is attached to the top side of said fork (36) extending away from said fork shaft (2). Referring to FIG. 15, said shaft (34) having a reduced diameter relative to the top of said fork (36) for attachment to enable a one bolt alignment adjustment of said wheel assembly (30).

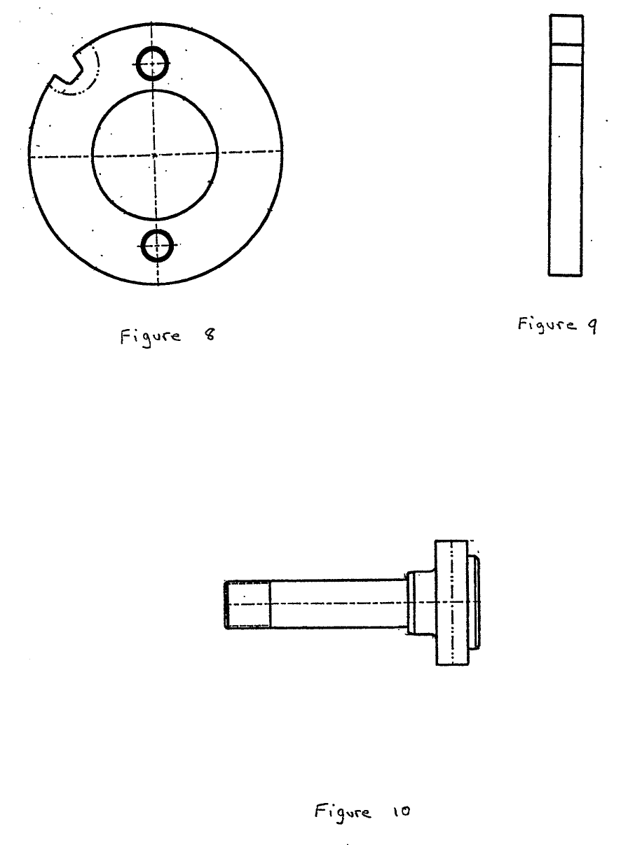

Referring to FIG. 7, a adjuster disk (17) is mounted onto said shaft (34). Referring to FIG. 8, said adjuster disk (17) having a larger inner diameter (1.970+/−0.002) relative to said shaft (34), referring to FIG. 10, said shaft (34) diameter (1.990+/−0.002). Referring to FIG. 8, said adjuster disk (17) notched depth is (1.72) from the center of the said adjuster disk (17) to enable a reverse locking pin mechanism to engage. The said adjuster disk (17) having a cylinder hole to enable fastening with a hexhead cap screw (16) to the said fork (36). Referring to FIG. 7, said shaft (34) is attached to said fork (36) having said adjuster disk (17) as the means to adjust the relative angle, thus the first and second members engage and release into varied angles rotatable about said shaft (34).

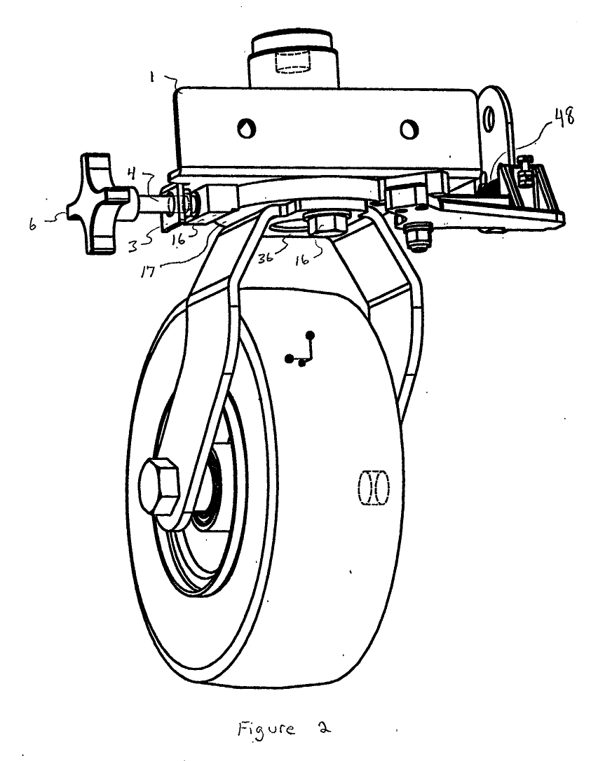

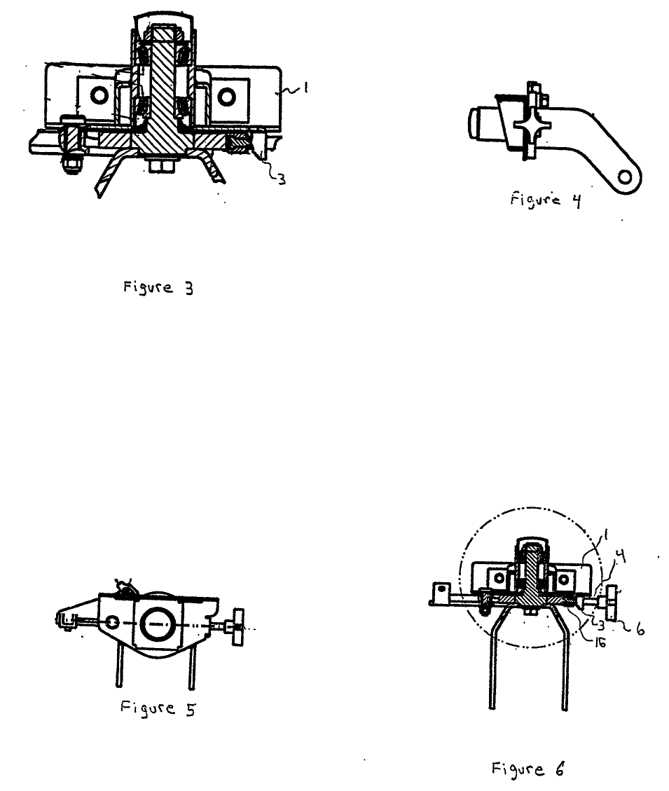

Referring to FIG. 2, a radius lock assembly comprising a pronged knob (6) attached to a wedge stop (4) positioned perpendicular to said prong knob (6) extending toward adjuster disk (17). Referring to FIG. 3, said wedge stop (4) is secured by a guide attached a detent arm (3) enabling rotation of said wedge stop (4) for tightening of adjuster disk (17). A jaw (16) is attached to said wedge stop (4) to enable securing of said adjuster disk (17). The detent arm (3) is fastened to a hub bracket (1).

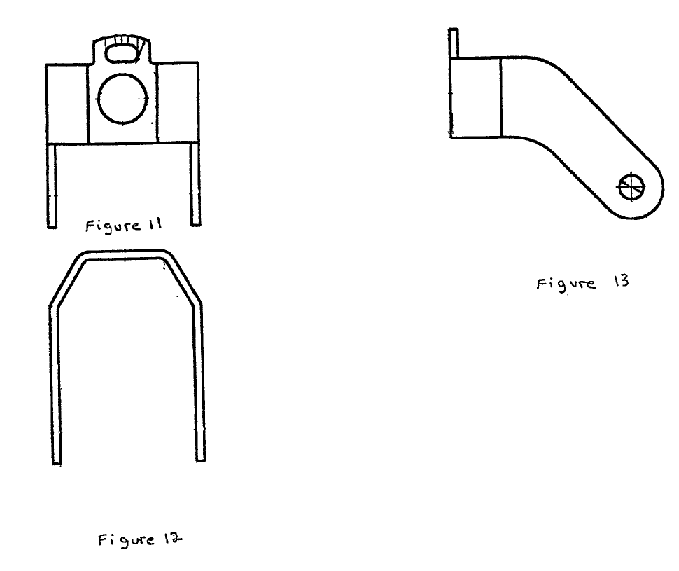

Referring to FIG. 2, a hexhead cap screw (16) extends through said fork (36) (refer to FIG. 12) attaches to said adjuster disk (17) (refer to FIG. 8) securing said adjuster disk (17) to said fork (36).

Referring to FIG. 5, a reverse locking pin assembly includes a guide attached to the detent arm (3). Referring to FIG. 7, a locking pin (46) is detachably contained in the guide and engagable with the adjuster disk (17) element notch. Referring to FIG. 2, a pull rod (48) is releasably contained in the guide and engagable with the said locking pin (46).

Referring to FIG. 3, said hub bracket (1) having a plate including a bottom and side face, as well as a cylindrical tube attached to bottom face extending upward from bottom face parallel to side face. A guide attached to the inside of said cylindrical tube secures a set of lower cone bearings (9) and a set of upper cone bearings (9). The said lower set of cone bearings (9) are positioned inside of said cylindrical tube that is closest to said plate bottom face. A bevel washer (10) is positioned on top of said set of upper cone bearings (9) wherein it is positioned farthest away from the plate bottom face. Referring to FIG. 7, said shaft (34) extends through the said hub bracket (1) bottom face, through said cylindrical tube, passing through the set of lower cone bearings (9) and set of upper cone bearings; referring to FIG. 3, through said bevel washer (10), and finally is secured by a ¾-16 lock nut (11) that attaches to said shaft (34). A dust cap (12) attaches to the inside of said cylindrical tube top extending downward to said bevel washer (10). The said hub bracket (1) attaches to a supported article, such as a linestriper.

FIG. 16 shows the preferred embodiment of the rotation pin 144 wherein a zerk fitting 146 is located in a recessed opening 148 in the head 150 of pin 144. A longitudinal passage 152 leads from fitting 146 to radial passage 154 and allows grease or other lubricant to be injected between the pin 144 and wheel 26.

It is contemplated that various changes and modifications may be made to the wheel assembly without departing from the spirit and scope of the invention as defined by the following claims.

What is claimed is:

1. A locking swivel caster wheel assembly comprising:
a mounting plate includes a guide attached to a tube wherein the tube fastens a shaft attached to a fork having a adjuster disk as the means to adjust relative angle, the first and second members engage and release into varied angles rotatable about said shaft;
a radius lock assembly includes a guide attached to a arm wherein the radius lock assembly having a wedge stop as the means to adjust relative angle, said wedge stop and adjuster disk engage and release into varied angles rotatable about said shaft;
a locking pin assembly wherein the locking pin assembly includes a guide attached to the arm, a locking pin detachably contained in the guide and engagable with the adjuster disk element notch, and a pull rod releasably contained in the guide and engagable with the said locking pin;
a plurality of wheel attachments contained within said wheel assembly;
a rotation pin having a left and right spacer about said wheel inside said fork shafts, said rotation pin having a spacer between said fork shafts said wheel attached to both ends of said rotation pin having said spacer between said wheel and outside said fork shafts.
